(19) United States
(12) Patent Application Publication
(10) Pub. No.: US 2010/0195551 A1
(43) Pub. Date: Aug. 5, 2010

(54) NETWORK SYSTEM, COMMUNICATION METHOD, DEPENDENT WIRELESS APPARATUS, AND CONTROL WIRELESS APPARATUS

(75) Inventor: Ichiro Kuwana, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/669,884

(22) PCT Filed: Sep. 22, 2008
(86) PCT No.: PCT/JP2008/067593

§ 371 Date: Jan. 20, 2010

(30) Foreign Application Priority Data
Sep. 25, 2007 (JP) 2007-248182

(51) Int. Cl. H04W 52/02

(52) U.S. Cl. 370/311

(57) ABSTRACT

A control wireless apparatus transmits a sleep command for causing a plurality of dependent wireless apparatuses to enter a sleep mode in which an intermittent receiving operation is performed. The dependent wireless apparatuses enter a sleep mode in which reception is intermittently performed, on receipt of the sleep command from the control wireless apparatus or via another dependent wireless apparatus. The dependent wireless apparatuses each relay the received sleep command to another dependent wireless apparatus.

### TECHNICAL FIELD

The present invention relates to a multihop network system, a communication method, a dependent wireless apparatus, and a control wireless apparatus.

### BACKGROUND ART

Heretofore, a method has been proposed for connecting a home gateway set in a living room to a personal computer placed in a study via wireless LAN, and viewing video data from the home gateway (Japanese Patent Laid-Open No. 2004-32546). According to this method, the personal computer instructs the home gateway to enter standby mode when viewing has ended.

Japanese Patent Laid-Open No. 2004-32546 relates to networks in which a plurality of wireless communication apparatuses communicate one-to-one, although in recent years point-to-multipoint networks have emerged. Further, multihop networks and mesh networks have also been proposed as a development of this. A multihop network enables indirect communication for a plurality of wireless communication apparatuses that cannot communicate directly, as a result of some of the apparatuses also functioning as relay devices. A mesh network, which constitutes an exemplary multihop network, enables a plurality of relay paths to be secured. Wireless communication apparatuses are therefore able to select a signal having the fewest errors out of the signals received from different relay paths.

Incidentally, with such multihop and mesh networks, there is also demand for a technique for causing wireless communication apparatuses belonging to a network to enter standby mode. This could conceivably be realized by transmitting, directly or via a relay device, an instruction for entering standby mode from a master device to wireless communication apparatuses functioning as slave devices. The transmission unit and the like in the wireless communication apparatuses that receive the command thus go to sleep, with only the receiving unit intermittently executing reception.

On the other hand, restarting the sleeping wireless communication apparatuses could conceivably be realized by transmitting a return command from the master device to the slave devices. Therefore, wireless communication apparatuses that are able to receive this return command safely restart.

However, with a multihop network, the return command is not relayed since the transmission unit in the wireless communication apparatuses acting as relay devices is sleeping. Wireless communication apparatuses (e.g., other slave devices subordinate to a given slave device) that are not able to receive the return command directly from the master device are therefore unable to restart. This makes it impossible to recover the original network topology.

### DISCLOSURE OF INVENTION

In view of this, a feature of the present invention is to resolve at least one of these and other problems. For example, a feature of the present invention is to enable the original network topology to be recovered by restarting sleeping wireless communication apparatuses belonging to a multihop network. Note that other problems will become apparent throughout the specification.

The present invention can, for example, be applied to a network system that includes a control wireless apparatus and a plurality of dependent wireless apparatuses.

The control wireless apparatus transmits a sleep command for causing the plurality of dependent wireless apparatuses to enter a sleep mode in which an intermittent receiving operation is performed. The dependent wireless apparatuses, on receipt of the sleep command from the control wireless apparatus or via another dependent wireless apparatus, enter a sleep mode in which reception is performed intermittently. The dependent wireless apparatuses each relay the received sleep command to another dependent wireless apparatus.

According to another aspect of the present invention, the control wireless apparatus transmits a startup command for causing a dependent wireless apparatus that has entered a sleep mode in which an intermittent receiving operation is performed to cancel the sleep mode. The dependent wireless apparatuses, on receipt of the startup command from the control wireless apparatus or via another wireless communication apparatus, cancel the sleep mode and enter a startup state. The dependent wireless apparatuses each relay the received startup command to another dependent wireless apparatus.

Further features of the present invention will become apparent from the following description of exemplary embodiments (with reference to the attached drawings).

### BRIEF DESCRIPTION OF DRAWINGS

FIG. 1 shows an exemplary network system according to a preferred embodiment.

FIG. 2 is an exemplary sequence diagram illustrating the processing of dependent stations up to entering a sleep state from a normal operating state.

FIG. 3A is a block diagram showing an example of a control station and a dependent station according to a preferred embodiment.

FIG. 3B shows an exemplary topology map according to a preferred embodiment.

FIG. 4 is a flowchart showing a sleep mode entry process of the control station in a preferred embodiment.

FIG. 5 is a flowchart showing a sleep mode entry process of the dependent stations in a preferred embodiment.

FIG. 6 illustrates a problem solved by the present invention.

FIG. 7 is a sequence diagram showing an exemplary process of entering an operating mode from sleep mode according to a preferred embodiment.

FIG. 8 is a flowchart showing an exemplary return process executed by the control station according to a preferred embodiment.

FIG. 9 is a flowchart showing an exemplary process of returning from sleep mode executed by the dependent stations according to a preferred embodiment.

FIG. 10 is a sequence diagram showing an exemplary process of entering an operating mode from sleep mode according to a preferred embodiment.

FIG. 11 shows an exemplary process of returning from sleep mode to another operating mode according to a preferred embodiment.

FIG. 12 is a flowchart showing an exemplary return process executed by the control station according to a preferred embodiment.

### BEST MODE FOR CARRYING OUT THE INVENTION

Hereinafter, preferred embodiments of the present invention will be given. The individual embodiments described below will be helpful in understanding a variety of concepts from the generic to the more specific. Further, the technical scope of the present invention is defined by the claims, and is not limited by the following individual embodiments.

### First Embodiment

The configurations and operations of a control wireless apparatus (hereinafter, control station) and dependent wireless apparatuses (hereinafter, dependant stations) of the present embodiment will be described. Note that both the control station and the dependent stations are wireless communication apparatuses. The wireless communication apparatuses may function as either a control station or a dependant station, or simultaneously as both a control station and a dependant station. Note that the control station is also called a master device, and that the dependent stations are also called slave devices.

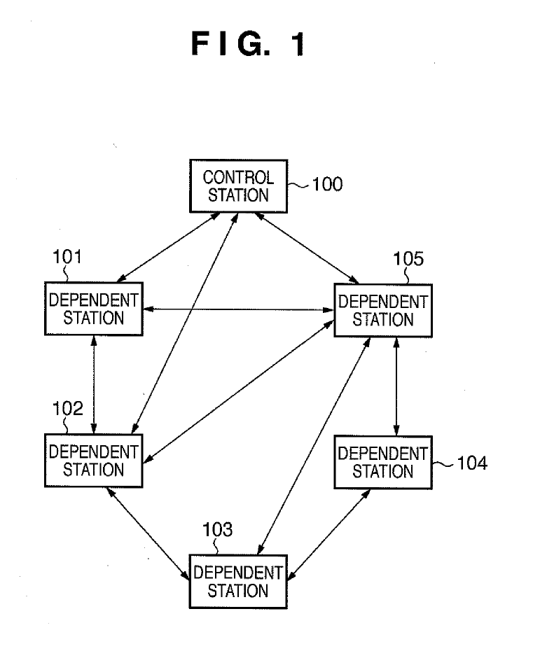

FIG. 1 shows an exemplary network system according to the present embodiment. Note that the network system may also be called a wireless communication system. A control station 100 constitutes a mesh network together with dependent stations 101, 102, 103, 104 and 105. The control station 100 broadcasts data to the dependent stations.

However, with the example shown in FIG. 1, transmission signals from the control station 100 do not reach the dependent stations 103 and 104 directly. This is normally due to there physically being too much distance between the control station and the dependent stations 103 and 104.

In the present embodiment, any of the dependent stations may also function as a relay device in order to resolve this problem. For example, the dependent station 103 is able to receive a signal relayed by the dependent stations 101 and 102. The dependent station 103 is also able to receive a signal relayed by the dependent station 105. The dependent station 103 is further able to receive a signal relayed by the dependent stations 105 and 104. The dependent stations thus use received signals, together with retransmitting received signals as relay signals.

The dependent station 104 is able to receive signals from the dependent stations 103 and 105, although in reality only receives signals from the dependent station 103. This is because the control station 100 has instructed the dependent station 104 in advance to only receive signals from the dependent station 103. The control station 100 acquires communication states for available communication paths to each dependent station, and selects one or more communication paths with a favorable communication state. In the case of a plurality of communication paths being selected, the dependent station receives respective signals from the plurality of communication paths, and selects the highest quality signal. If the communication states of the communication paths change, the control station may change the communication paths to the dependent stations. For example, in the case where, as communication paths to the dependent station 103, there is a route via only the dependent station 105 and a route via the dependent station 104, the control station 100 may interchange the transmission order of the dependent stations 104 and 105.

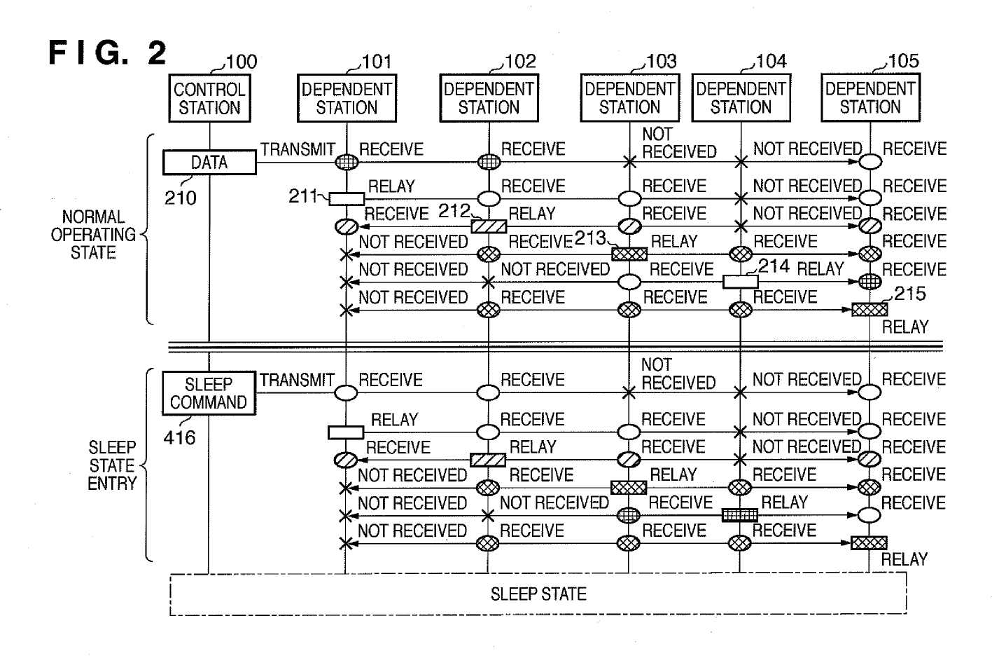

FIG. 2 is an exemplary sequence diagram illustrating the processing of the dependent stations up to entering a sleep state from a normal operating state. The dependent stations 101, 102 and 105 are able to directly receive data 210 transmitted by the control station 100, but the dependent stations 103 and 104 are not.

Incidentally, in the case where the control station 100 and the dependent stations perform transmission using a single frame composed of a plurality of timeslots, the control station 100 assigns a transmission order to the dependent stations in advance. For example, assume that the transmission order is the dependent stations 101, 102, 103, 104 and 105. In this case, the dependent station 101, which has successfully received data 210 transmitted from the control station 100, transmits the data 210 as data 211 at a transmission timing predetermined by the control station.

As seen from FIG. 2, the data 211 transmitted by the dependent station 101 is received by the dependent stations 102, 103 and 105. Further, the dependent station 102, which has been assigned the next place in the transmission order, selects the most reliable data out of the data 210 and 211 received from the control station 100 and the dependent station 101. When the transmission timing assigned thereto arrives, the dependent station 102 transmits the selected data as data 212.

The data 212 transmitted by the dependent station 102 is received by the dependent stations 103, 105 and 101. The dependent station 103 selects the most reliable data out of the data 211 and 212 received from the dependent stations 101 and 102. When the transmission timing assigned thereto arrives, the dependent station 103 transmits the selected data as data 213.

Hereinafter, the dependent station 104 transmits data 214 and the dependent station 105 transmits data 215 with similar procedures. Highly reliable data can thereby be transmitted to all of the dependent stations.

The control station 100 transmits a sleep command (sleep state entry command) to cause the dependent stations to enter a sleep state from a normal operating state. The control station 100 is thus provided with a transmission unit which transmits a sleep command for causing a plurality of dependent stations to enter a sleep mode in which an intermittent receiving operation is performed. The sleep command is conveyed to the dependent stations as the aforementioned data 210. On receipt of a sleep command, the dependent stations transfer (relay) the sleep command as necessary, before entering a sleep state (sleep mode). All of the dependent stations thereby enter a sleep state. Note that the dependent stations are provided with a receiving unit which receives a sleep command for entering a sleep mode in which an intermittent receiving operation is performed, a sleep unit which, on receipt of the sleep command from the control wireless apparatus or via another dependent wireless apparatus, enters a sleep mode in which reception is intermittently performed, and a relay unit which relays the received sleep command to another dependent wireless apparatus.

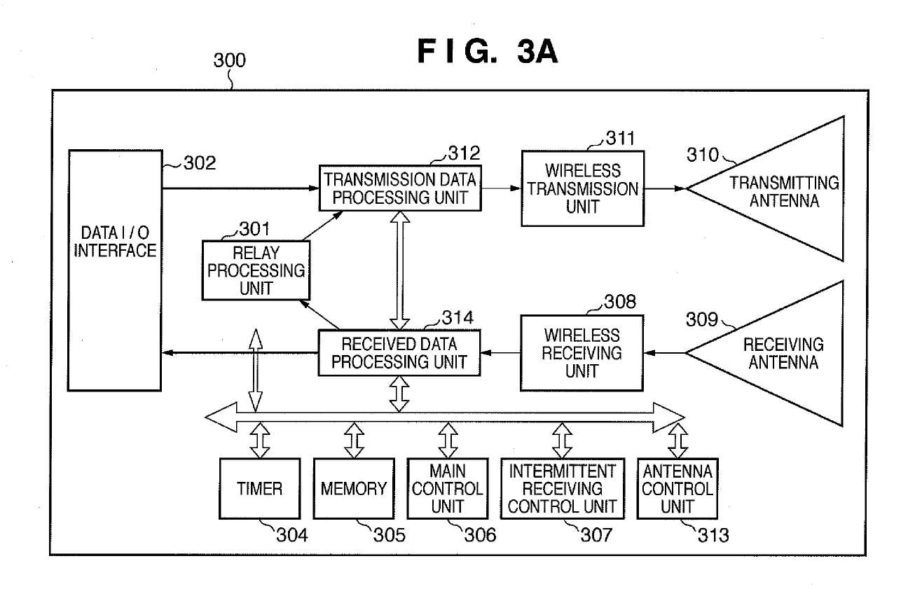

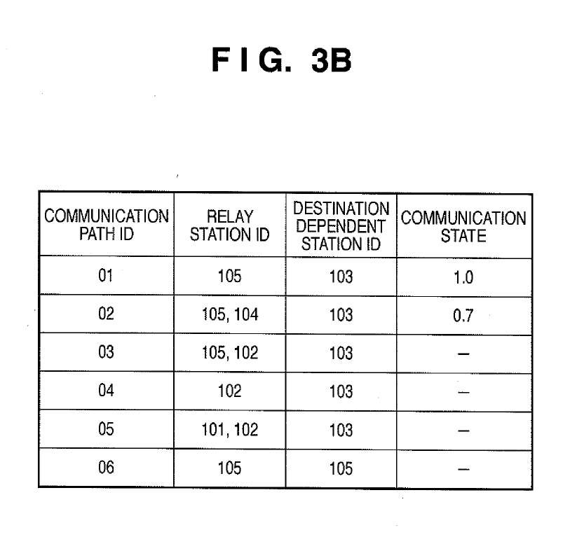

FIG. 3A is a block diagram showing an example of a control station and a dependent station according to the present embodiment. A wireless communication apparatus 300 constitutes the aforementioned control station 100 and/or a dependent station. A transmitting antenna 310 and a receiving antenna 309 are directivity-controllable antennas such as phased array antennas or the like. The antenna control unit 313 is a control circuit that controls the directivity of the transmitting antenna 310 and the receiving antenna 309 and the direction of the main beam. Note that if a duplexer that switches between transmitting and receiving is added, a single antenna can be used as the transmitting antenna 310 and the receiving antenna 309.

A wireless receiving unit 308 is a circuit that demodulates a received signal received by the receiving antenna 309. A wireless transmission unit 311 is a circuit that modulates transmission target data, and outputs the modulated data to the transmitting antenna 310.

Various information processing apparatuses, such as a personal computer or a printer, can be connected to the wireless communication apparatus 300 via a data input/output (I/O) interface 302. Data from these external devices is received by the data I/O interface 302. Also, received data is output from the data I/O interface 302 to an external device.

Data received by the data I/O interface 302 is sent to a transmission data processing unit 312. The transmission data processing unit 312 performs processing on the data, such as inserting a specific timeslot in a single frame, to create transmission target data. The transmission target data is modulated by the wireless transmission unit 311 and transmitted from the transmitting antenna 310.

A received signal received by the receiving antenna 309 is demodulated by the wireless receiving unit 308, and reassembled to the original data by a received data processing unit 314. When the same data is respectively received via a plurality of communication paths, the received data processing unit 314 measures the quality of the data and selects the best quality data. In terms of quality there is, for example, the bit error rate, the frame error rate, the signal strength, the signal-to-noise ratio, and the signal-to-interference ratio, although these are merely illustrative. Original data thereby recovered is output from the data I/O interface 302 to an external device.

A relay processing unit 301 extracts, from received data, data to relay to another dependent station subordinate thereto or else to a superordinate dependent station or the control station, creates data for relaying, and sends the created data to the transmission data processing unit 312. The relay processing unit 301 thus constitutes an exemplary startup command relay unit which, in the case where there is another dependent station subordinate to a dependent station that has restarted as a result of receiving a startup command, relays the startup command to the other dependent station.

A main control unit 306 is a control unit such as a CPU. In the case where the wireless communication apparatus 300 operates as a dependent station, the main control unit 306 analyzes received data, and determines whether the received data is a sleep command, a startup command or a relay command. If the received data is a sleep command, the main control unit 306 instructs an intermittent receiving control unit 307 to enter sleep mode. The intermittent receiving control unit 307 thereby enters sleep mode, and starts up the wireless receiving unit 308 and the received data processing unit 314 intermittently to execute a signal reception process. Therefore, the intermittent receiving control unit 307, the wireless receiving unit 308 and the received data processing unit 314 constitute an exemplary receiving unit which, on receipt of a sleep command from the control station or via another dependent station, intermittently receives signals. Note that in sleep mode, power is not supplied to the relay processing unit 301, the transmission data processing unit 312, and the wireless transmission unit 311. Power savings are thereby achieved.

The control station is provided with a transmission unit which transmits a startup command for causing a dependent wireless apparatus that has entered a sleep mode in which an intermittent receiving operation is performed to cancel the sleep mode. On receipt of a startup command as a result of the intermittent receiving, the main control unit 306 instructs the intermittent receiving control unit 307 to restart. The intermittent receiving control unit 307 thereby enters a normal operating mode. The main control unit 306 also recommences power supply to the sleeping units (e.g., wireless transmission unit 311, transmission data processing unit 312). The main control unit 306 constitutes an exemplary startup unit which cancels the sleep mode and enters a startup state, on receipt of a startup command from the control wireless apparatus or another dependent wireless apparatus.

On the other hand, in the case where the wireless communication apparatus 300 operates as the control station 100, the main control unit 306 creates a topology map, and stores the created topology map in a memory 305. Stored in the topology map are the device IDs (or device addresses, etc.) of the dependent stations, and the dependency relation between the dependent stations. The topology map functions as a so-called routing table. Also, the main control unit 306 acquires the communication states (e.g., error rate, signal strength, signal-to-noise ratio, etc.) of one or a plurality of communication paths from the control station to the dependent stations, and creates a communication state management table. The communication state management table may be integrated into the topology map. The main control unit 306 also decides the transmission order of the dependent stations (e.g., transmission timing, transmission timeslot), and creates a transmission order management table. These tables are also assumed to be stored in the memory 305.

When cancelling sleep mode, the main control unit 306 of the control station reads out information on the communication paths registered in the topology map to determine whether the communication paths were successfully recovered. If there are any communication paths that were not recovered, the main control unit 306 transmits a relay command to a corresponding dependent station to relay (transfer, proxy transmit) a startup command to a subordinate dependent station. That is, the main control unit 306 is provided with an instruction unit which instructs a dependent wireless apparatus to relay a startup command. If there are still any communication paths that cannot be recovered, the main control unit 306 attempts to establish a new communication path. Note that a timer 304 is a timer circuit for measuring the time from when each command is transmitted until when a corresponding response is received.

FIG. 3B shows an exemplary topology map according to the present embodiment. The topology map is a type of table or database that is stored in the memory 305 as a file. The main control unit 306 may delete communication paths that have not been used for a given period of time or communication paths whose communication state has relatively deteriorated. Included in the topology map are communication path IDs for identifying the communication paths. Relay station IDs for identifying dependent stations that constitute relay stations, destination dependent station IDs for identifying dependent stations that constitute final destinations, and communication states representing the quality of respective communication paths may also be registered in the topology map. The memory 305 is thus an exemplary topology storage unit storing topology information. Topology information includes identification information on dependent stations belonging to the network system prior to the dependent stations entering sleep mode, and information representing the connection relation between the plurality of dependent stations in the network system. Therefore, the topology map constitutes exemplary topology information.

Entering Sleep Mode

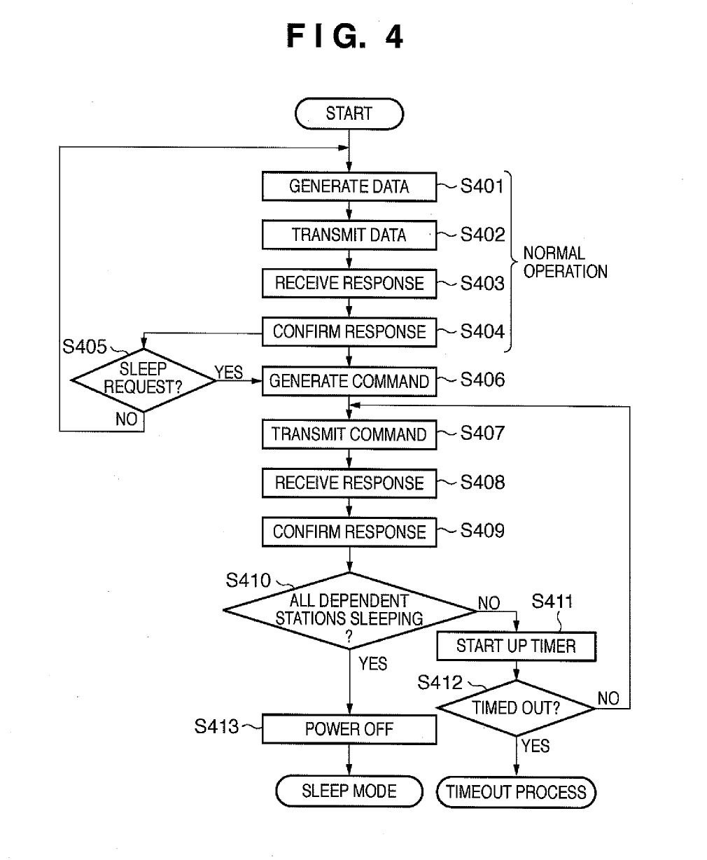

FIG. 4 is a flowchart showing a sleep mode entry process of the control station in the present embodiment. Here, the control station 100 is assumed to initially be operating in another operating mode different from sleep mode (e.g., normal operating mode [S401 to S404]).

At step S401, the main control unit 306 causes the transmission data processing unit 312 to create data for transmission based on data received from an external device by the data I/O interface 302 or data read out from the memory 305.

At step S402, the wireless transmission unit 311 transmits the created data for transmission from the transmitting antenna 310. At step S403, the wireless receiving unit 308 receives data (response) transmitted from a dependent station, using the receiving antenna 309. The received data processing unit 314 sends the received response to the main control unit 306.

At step S405, the main control unit 306 determines whether a sleep request has been input from an operation unit or the like (not shown). A sleep request is an instruction for requesting that sleep mode be entered. If a sleep request has not been input, the processing returns to step S401, and the main control unit 306 stays in the normal operating mode. On the other hand, if a sleep request has been input, the processing proceeds to step S406.

At step S406, the main control unit 306 generates a sleep command for causing a dependent station to sleep. At step S407, the main control unit 306 transmits the generated sleep command, using the transmission data processing unit 312 and the wireless transmission unit 311. Note that the sleep command is transmitted by broadcast or multicast. The main control unit 306, the transmission data processing unit 312 and the wireless transmission unit 311 thus constitute an exemplary command transmission unit which transmits a sleep command for causing a plurality of dependent station to enter a sleep mode in which an intermittent receiving operation is performed.

At step S408, the main control unit 306 receives a response transited from a dependent station, using the wireless receiving unit 308 and the received data processing unit 314. At step S409, the main control unit 306 analyzes the received response, and confirms the dependent station constituting the transmission origin of the response.

At step S410, the main control unit 306 determines whether a response has been received from all of the dependent stations registered in the topology map, that is, whether all of the dependent stations are sleeping. If there are still any dependent stations that are not sleeping, the processing proceeds to step S411, where the main control unit 306 starts up the timer 304. Note that if the timer 304 has already been started up, step S411 is skipped.

At step S412, the main control unit 306 determines whether the timer 304 has timed out. Timeout is determined in order to detect a situation where a dependent station is unable to return a response due to having crashed or being geographically distant. When the timer 304 has timed out, the main control unit 306 executes a timeout process. On the other hand, if the timer 304 has not timed out, the processing returns to step S407 and the main control unit 306 retransmits the sleep command.

The main control unit 306 thereby turns off the power supply by the power supply circuit at step S413, when all of the dependent stations are sleeping. The main control unit 306 also thereby enters sleep mode.

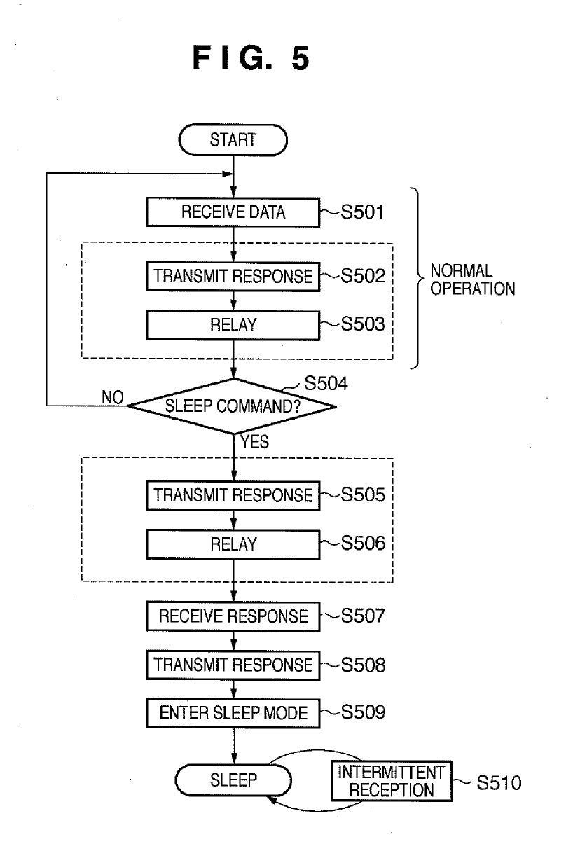

FIG. 5 is a flowchart showing a sleep mode entry process of the dependent stations in the present embodiment. At step S501, the main control unit 306 of the dependent stations receives data (or a command) transmitted from a dependent station, using the receiving antenna 309. The received data processing unit 314 sends the received data or command to the main control unit 306.

At step S502, the main control unit 306 transmits a response, using the wireless transmission unit 311 and the transmitting antenna 310. Note that in the case where the dependent station functions as a relay station, the relay processing unit 301, at step S503, transmits a command or data to a subordinate dependent station by returning the received command or data from the received data processing unit 314 to the transmission data processing unit 312. A command or data is thereby relayed to a subordinate dependent station.

At step S504, the main control unit 306 determines whether the received command is a sleep command. If the received command is not a sleep command, the processing returns to step S501, and the main control unit 306 stays in normal operating mode. If the received command is a sleep command, the processing proceeds to step S505.

At step S505, the main control unit 306 transmits a response showing that the sleep command has been received (i.e., that the dependent station will now be entering sleep mode), using the wireless transmission unit 311 and the transmitting antenna 310. At step S506, the main control unit 306 relays the sleep command. Note that if the sleep command has already been relayed at step S503, step S506 is skipped.

At step S507, the main control unit 306 receives a response transmitted from another dependent station, using the receiving antenna 309 and the wireless receiving unit 308. At step S508, the main control unit 306 transmits (relays) this response, using the relay processing unit 301, the wireless transmission unit 311 and the transmitting antenna 310.

At step S509, the main control unit 306 enters sleep mode. For example, the main control unit 306 stops supply of power from the power supply circuit to the relay processing unit 301, the transmission data processing unit 312, the wireless transmission unit 311, and the like. The main control unit 306 also instructs the intermittent receiving control unit 307 to enter sleep mode. The main control unit 306 thus constitutes an exemplary mode control unit which, on receipt of a sleep command, causes the receiving unit to enter sleep mode from another operating mode.

At step S510, the intermittent receiving control unit 307 causes intermittent receiving to be executed by periodically supplying power to units required in the reception process, such as the received data processing unit 314 and the wireless receiving unit 308, in accordance with this instruction.

Returning from Sleep Mode

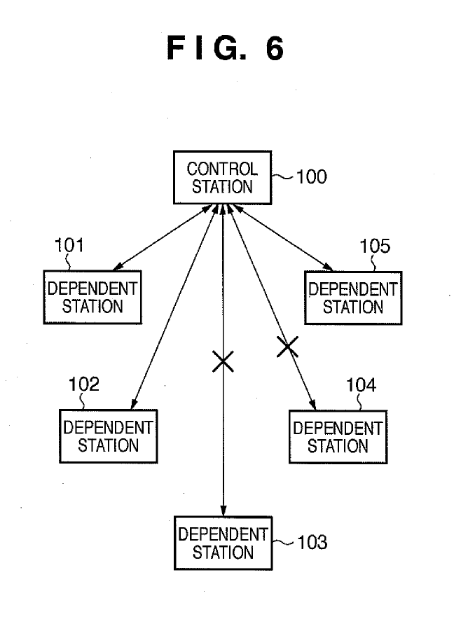

FIG. 6 illustrates a problem solved by the present invention. Heretofore, in the case where sleeping dependent stations belonging to a network were restarted, only the dependent stations 101, 102 and 105 located in a range within which radio waves from the control station 100 can be directly received were able to restart. That is, the startup command was not conveyed to the dependent stations 103 and 104 since the mesh communication paths secured pre-sleep as shown in FIG. 1 do not exist. Hence, a problem with multihop networks was that the original network topology was not recoverable once the wireless communication apparatuses entered sleep mode.

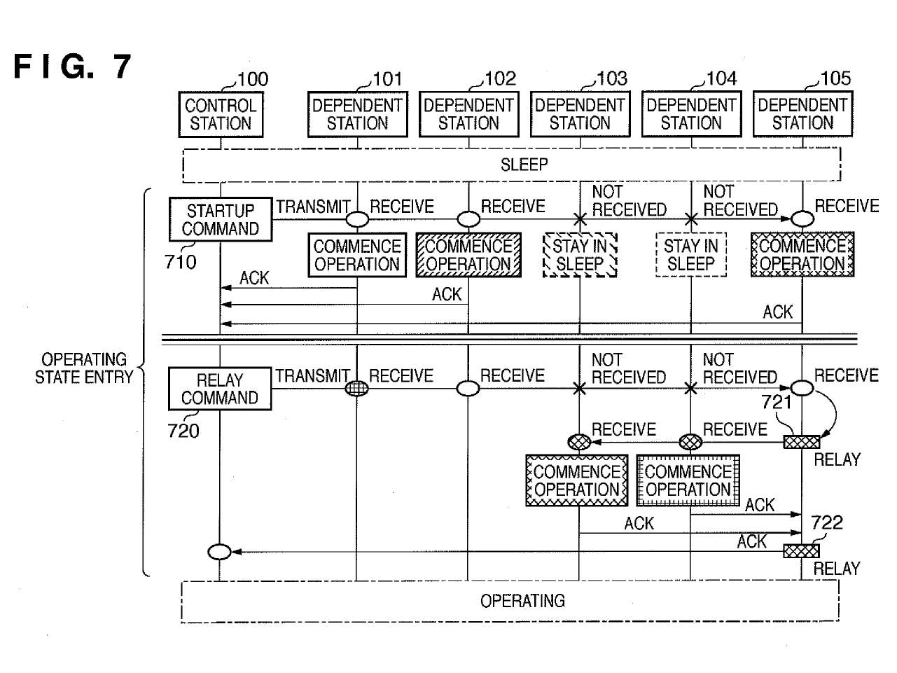

FIG. 7 is a sequence diagram showing an exemplary process of entering an operating mode from sleep mode according to the present embodiment. Here, the aforementioned dependent stations are assumed to have entered sleep mode (sleep state).

The control station 100 relatively transmits a startup command 710 to the dependent stations in the sleep state, using a wide directivity. The dependent stations 101, 102 and 105 that were able to receive the startup command 710 restart. The restarted dependent stations 101, 102 and 105 transmit responses (ACK) showing that restart has been performed to the control station 100. Note that at this point, the dependent stations 103 and 104, being unable to receive the startup command, remain in the sleep state.

The control station 100 detects that the dependent stations 103 and 104 have not restarted, from the responses that are sent back. The control station 100 acquires the communication states and the communication paths prior to entering the sleep state from the topology map. The control station 100 designates a communication path whose communication state prior to entering sleep mode was relatively favorable out of the plurality of communication paths, and selects a superordinate dependent station that belongs to the designated communication path. For example, the control station 100 selects the optimal dependent station to relay the startup command out of the dependent stations currently operating, based on the acquired communication states and communication paths. Normally, the optimal dependent station will be a dependent station located on a communication path with the best communication state. If there is a communication path whose communication state is relatively favorable (exceeds a prescribed reference value), a communication path that is not the best may be selected. In the case of there being a plurality of candidates, the control station 100 may decide by random numbers or the like. Note that another dependent station (e.g., dependent station 105) that can communicate with the dependent stations 103 and 104 which have not started up may be selected as the optimal dependent device.

The control station 100 transmits to the selected dependent station 105 a relay command 720 for requesting that a startup command be relayed or proxy transmitted. That is, the control station 100 is provided with a designation unit which designates a dependent wireless apparatus for relaying a startup command. Having received the relay command 720, the dependent station 105 transmits a startup command 721 in place of the control station. Further, the dependent station 105 waits for a predetermined period for a response (ACK) from the dependent stations 103 and 104. Having received the startup command 721, the dependent stations 103 and 104 restart and transmit responses showing that restart has been performed to the dependent station 105. The dependent stations 103 and 104 are thus provided with a response transmission unit which transmits a response notifying that restart has been performed.

The dependent station 105, having received the responses from the dependent stations 103 and 104, relays these responses to the control station 100. All of the dependent stations are thereby able to return from sleep mode.

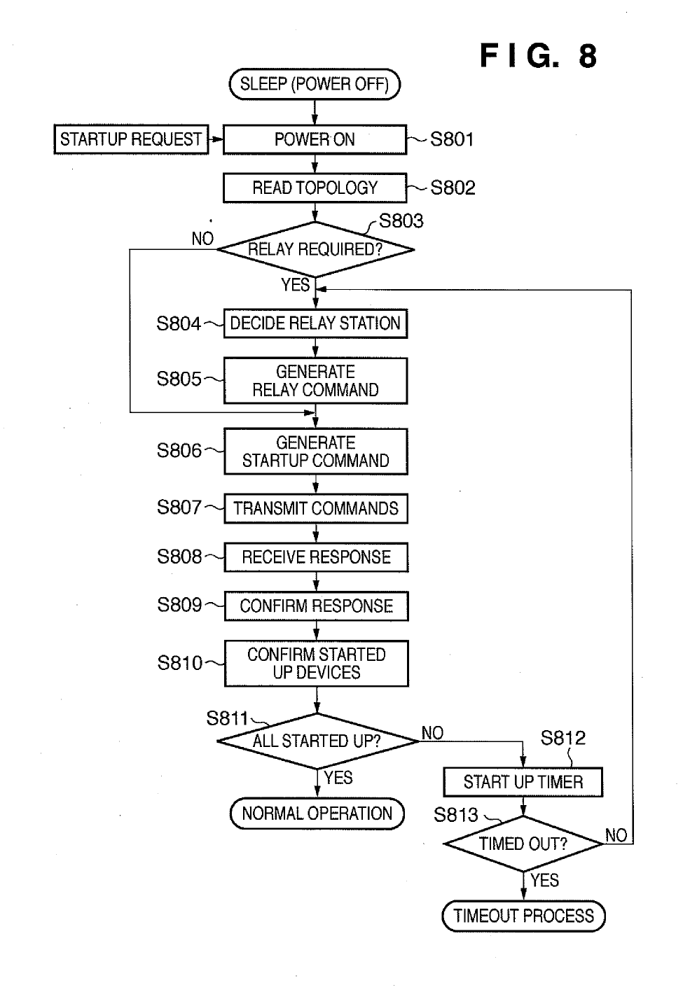

FIG. 8 is a flowchart showing an exemplary return process executed by the control station according to the present embodiment. At step S801, the power supply circuit commences supply of power to the various units, once a startup request has been input from the operation unit.

At step S802, the main control unit 306 reads the pre-sleep topology map from the memory 305. At step S803, the main control unit 306 analyzes the content of the topology map, and determines whether there are any dependent stations that require relaying. According to the topology map in FIG. 3B, for example, relaying is not required for the communication path with the communication path ID “06”, but because relay station IDs are registered for the other communication paths, the main control unit 306 determines that relaying is required. If relaying is not required, the processing skips to step S806. On the other hand, if relaying is required, the processing proceeds to step S804.

At step S804, the main control unit 306 decides the dependent stations to function as relay stations in accordance with the topology map. For example, the dependent station 105 is decided as the relay station for the communication path with the communication path ID “01”. Note that the communication path with the best communication state is selected in the case of there being a plurality of communication paths. The main control unit 306 thus constitutes an exemplary selection unit which specifies a communication path whose communication state prior to the dependent stations entering sleep mode is relatively favorable, and selects a dependent station belonging to the specified communication path. Also, the memory 305 constitutes an exemplary state storage unit which stores state information representing the communication state of one or a plurality of communication paths from the control station to the dependent stations.

At step S805, the main control unit 306 generates a relay command constituting a request command for requesting that the dependent station 105 relay to the dependent stations 103 and 104. At step S806, the main control unit 306 generates a startup command to convey to the dependent stations 103 and 104.

At step S807, the main control unit 306 transmits the relay command and the startup command using the transmission data processing unit 312 and the wireless transmission unit 311. The main control unit 306, the transmission data processing unit 312 and the wireless transmission unit 311 thus constitute an exemplary command transmission unit which transmits a startup command for causing a plurality of dependent stations to enter another operating mode from sleep mode. The main control unit 306, the transmission data processing unit 312 and the wireless transmission unit 311 thus constitute an exemplary request command transmission unit which, in the case where a response is not received from another dependent station, transmits a request command to a superordinate dependent station to which the other dependent station is subordinate. The aforementioned relay command constitutes an exemplary request command for requesting that a superordinate dependent station to which another dependent station is subordinate relay a startup command to the other dependent station.

At step S808, the main control unit 306 receives responses from the dependent stations, using the wireless receiving unit 308 and the received data processing unit 314. At step S809, the main control unit 306 executes a response confirmation process. For example, the main control unit 306 analyzes the responses, and specifies the dependent stations that transmitted responses. Each response is assumed to include a device ID (device address) assigned to the dependent station that transmitted the response. That is, the main control unit 306 is provided with a determination unit which determines a dependent wireless apparatus that has entered a startup state, based on a received response.

At step S810, the main control unit 306 confirms which dependent stations have started up and which dependent stations have not started up, by comparing the IDs of the dependent stations that have started up with the IDs of the dependent stations registered in the topology map.

At step S811, the main control unit 306 determines whether all of the dependent stations have started up. If all of the dependent stations have started up, the main control unit 306 enters normal operating mode. On the other hand, if there remain any dependent stations that have not started up, the processing proceeds to step S812. The main control unit 306 thus constitutes an exemplary determination unit which determines whether a response has been received from another dependent station. The main control unit 306 also constitutes an exemplary restart determination unit which determines whether all of the dependent stations have restarted. A startup command can thereby be transmitted until all of the dependent stations belonging to the network system prior to the dependent stations entering sleep mode have restarted.

The processing proceeds to step S812, where the main control unit 306 starts up the timer 304. Note that if the timer 304 has already been started up, step S812 is skipped. At step S813, the main control unit 306 determines whether the timer 304 has timed out. Timeout is determined in order to detect a situation where a dependent station is unable to return a response due to having crashed or being geographically distant. When the timer 304 has timed out, the main control unit 306 executes a timeout process. On the other hand, if the timer 304 has not timed out, the processing returns to step S804 and the main control unit 306 retransmits the relay command and the startup command.

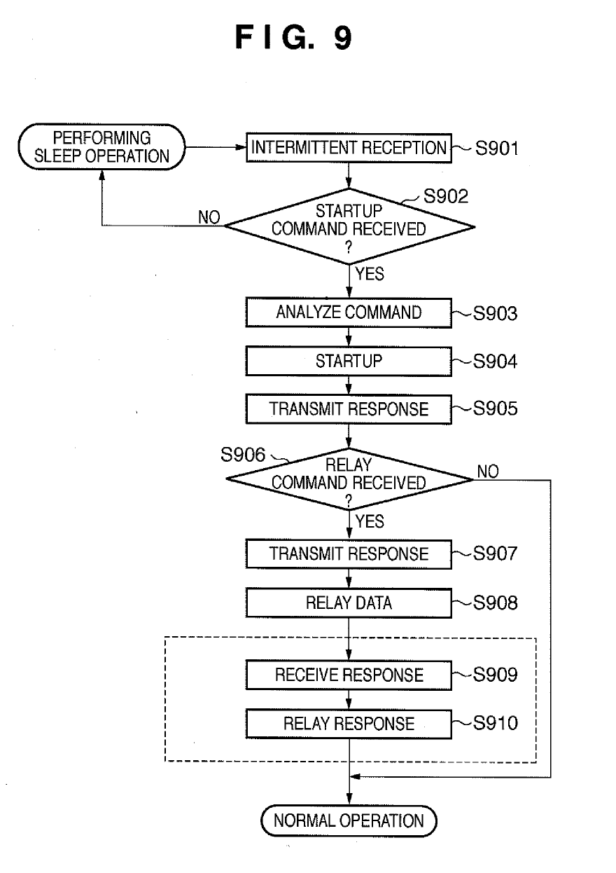

FIG. 9 is a flowchart showing an exemplary process of returning from sleep mode executed by the dependent stations according to the present embodiment. Here, the dependent stations are in the sleep state.

At step S901, the intermittent receiving control unit 307 starts up the received data processing unit 314 and the wireless receiving unit 308 at a periodical timing, and attempts to receive a startup command. At step S902, the intermittent receiving control unit 307 determines whether a startup command has been received. If a startup command has not been received, the intermittent receiving control unit 307 stays in sleep mode. On the other hand, if a startup command has been received; the processing proceeds to step S903.

At step S903, the intermittent receiving control unit 307 analyzes the received startup command. For example, the intermittent receiving control unit 307 confirms whether the received startup command is valid within the network system to which the dependent station belongs. If the received startup command is valid within the network system to which the dependent station belongs, the intermittent receiving control unit 307, at step S904, instructs the power supply circuit to supply power to the various units. The various units thereby restart (i.e., enter normal operating mode). The intermittent receiving control unit 307 thus constitutes a mode control unit which, on receipt of a startup command, controls the receiving unit to enter another operating mode from sleep mode.

At step S905, the main control unit 306 generates a response showing that restart has been performed, and transmits the generated response to the control station 100 using the transmission data processing unit 312 and the wireless transmission unit 311. The main control unit 306 and the like thus constitute an exemplary response transmission unit which transmits a response for notifying that restart has been performed, after having restarted as a result of receiving a startup command.

At step S906, the main control unit 306 determines whether a relay command requesting that a startup command be relayed to another dependent station subordinate thereto has been received. If a relay command has not been received, the main control unit 306 stays in normal operating mode. On the other hand, if a relay command has been received, the processing proceeds to step S907.

At step S907, the main control unit 306 transmits a response to the relay command. At step S908, the main control unit 306 relays data or a command (in particular, a startup command), using the relay processing unit 301. At step S909, the main control unit 306 waits for a fixed period for a response from another dependent station. On receipt of a response from another dependent station, the processing proceeds to step S910.

At step S910, the relay processing unit 301 executes a response relay process by returning the response from the other dependent station input by the received data processing unit 314 to the transmission data processing unit 312. The relay processing unit 301 and the like thus constitute an exemplary response relay unit which relays a response transmitted from another dependent station subordinate thereto to the control station.

According to the present embodiment, even when wireless communication apparatuses belong to a multihop network are put to sleep, they can all be restarted. Therefore, the original network topology constructed pre-sleep can be recovered.

Specifically, a startup command is relayed to a targeted subordinate dependent station via any of the superordinate dependent stations. While dependent stations that have crashed or are geographically distant cannot be restarted, normal dependent stations existing within a relayable range will be able to restart. Note that “superordinate” indicates a relatively close proximity to the control station on a given communication path, while “subordinate” indicates a relatively remote proximity.

Note that the network topology can be recovered quickly and reliably by selecting, as a relay station, a dependent station located on a communication path whose communication state before entering sleep mode was relatively favorable. In particular, such an effect can be anticipated in the case where there is no change in the positional relation or wireless environment of the control station and the dependent stations.

### Embodiment 2

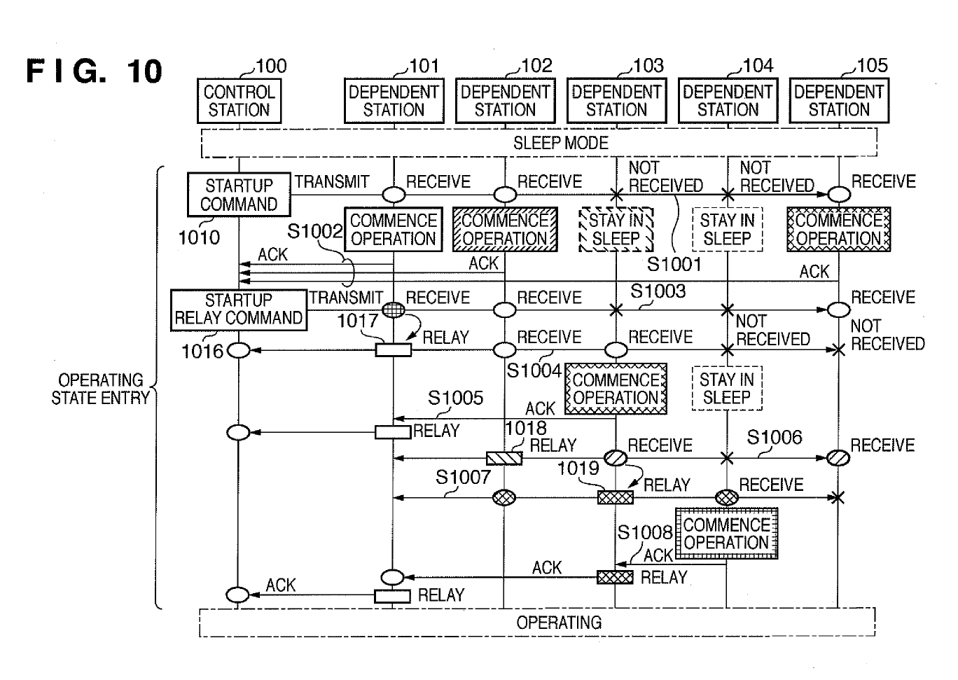

FIG. 10 is a sequence diagram showing an exemplary process of entering an operating mode from sleep mode according to the present embodiment. Here, the control station 100 is assumed to be able to communicate directly with the dependent stations 101, 102 and 105.

At step S1001, the control station 100 transmits a startup command 1010. The dependent stations 101, 102 and 105 receive the startup command 1010, and return to a normal operating mode. At step S1002, the restarted dependent stations 101, 102 and 105 transmit responses (ACK) to the control station 100.

At step S1003, the control station 100 transmits a relay command 1016 in order to start up the dependent stations 103 and 104 from which a response (ACK) was not received. Relaying or proxy transmission of a startup command is thus entrusted with the dependent stations 101, 102 and 105.

At step S1004, the dependent station 101, having received the relay command, transmits (relays) a startup command 1017, and waits for a fixed period for a response. The dependent station 103 is able to receive this startup command 1017, but the dependent station 104 is not. The dependent station 103 restarts after having received the startup command 1017. At step S1005, the dependent station 103 transmits a response after having restarted. The dependent station 101 relays the response from the dependent station 103 to the control station 100. The control station 100 thereby recognizes that the dependent station 103 has started up.

At step S1006, the dependent station 102 transmits (relays) a startup command 1018 and waits for a response. However, the dependent station 104, being unable to receive the startup command 1018, stays in sleep mode. On the other hand, the dependent station 103 receives the startup command 1018 from the dependent station 102.

At step S1007, the dependent station 103, having received the startup command 1018, transmits a startup command 1019 and waits for a response. The dependent station 104 restarts after having received the startup command 1019 from the dependent station 103.

At step S1008, the dependent station 104 transmits a response. The dependent station 103, having received the response from the dependent station 104, relays this response to the dependent station 101. Further, the dependent station 101 relays this response to the control station 100. All of the dependent stations thereby restart.

According to the present embodiment, the dependent station 101, having restarted in the first phase, relays a startup command, and the dependent station 103, having restarted in the second phase, also relays a startup command. All of the dependent stations are thus able to startup as a result of dependent stations that have newly started up relaying a startup command.

### Embodiment 3

Described in the present embodiment will be an exemplary directivity control unit which increases/widens the directivity of the antenna relatively when entering sleep mode, and decreases the directivity of the antenna when entering another operating mode.

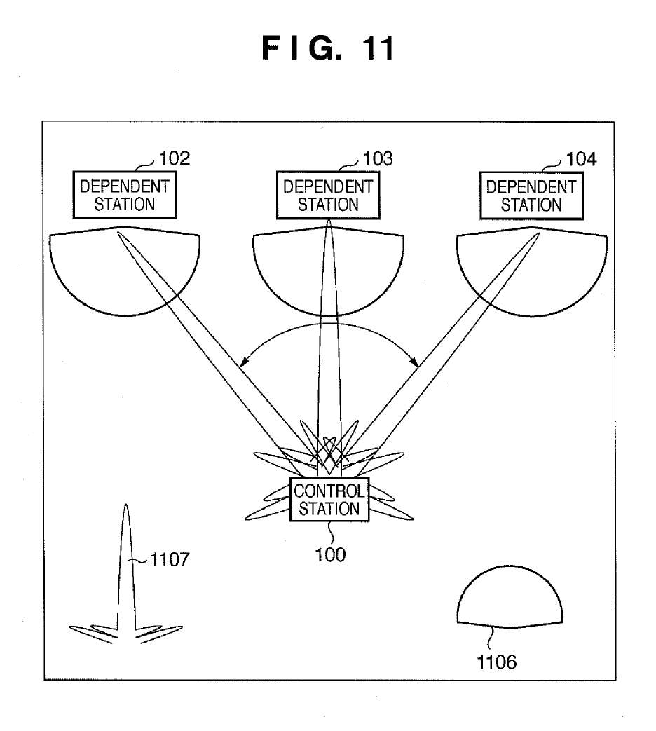

FIG. 11 shows an exemplary process of returning from sleep mode to another operating mode according to the present embodiment. In normal operating mode, the antenna control unit 313 of the dependent stations sets the directivity pattern of the receiving antenna 309 to a narrow directivity (high gain) 1107. On the other hand, when entering sleep mode, the antenna control unit 313 of the dependent stations changes the directivity pattern of the receiving antenna 309 to a wide directivity (low gain) 1106. This allows the dependent stations to readily receive a startup command from the control station 100, even when their relative positional relation to the control station 100 changes.

On the other hand, when transmitting a startup command, the antenna control unit 313 of the control station 100 sets the directivity pattern of the receiving antenna 309 to the narrow directivity (high gain) 1107. Further, the control station transmits a startup command and waits for responses, while sequentially switching (i.e., scanning) the directivity direction (radiation direction) of the main beam of the receiving antenna 309.

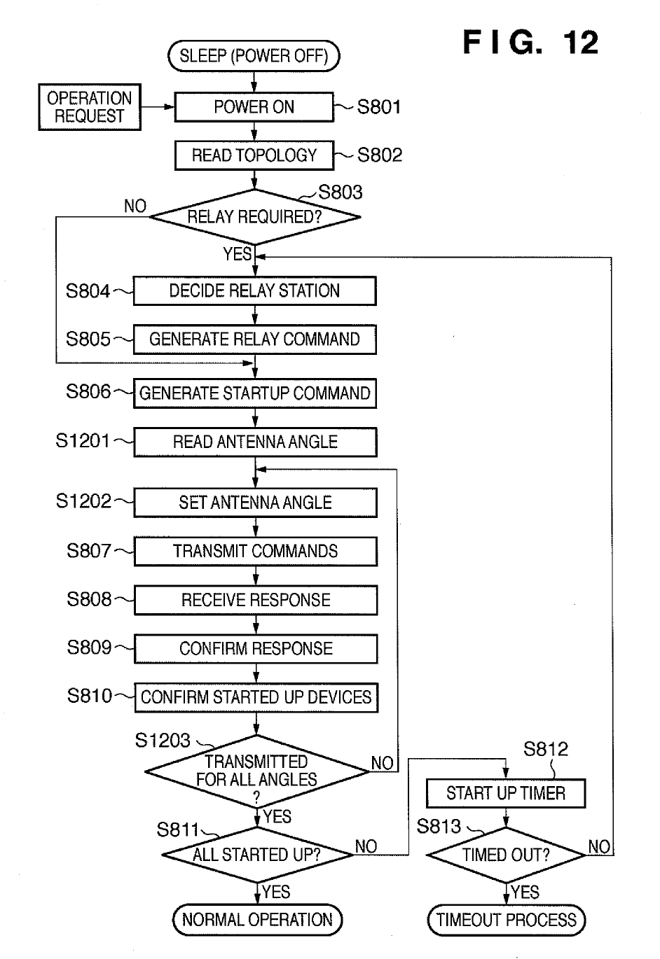

FIG. 12 is a flowchart showing an exemplary return process executed by the control station according to the present embodiment. Note that the same reference numerals are appended to places that have already been described. In particular, in embodiment 3, steps S1201 and S1202 have been added between steps S806 and 5807. Further, a step S1203 has been added between steps S810 and S811.

In step S1201, the main control unit 306 reads from a topology map or the like a transmitting antenna setting angle for communicating with a dependent station selected as a relay station. The memory 305 is assumed to store a transmitting antenna setting angle (direction of main beam) for each dependent station with which communication was performed pre-sleep.

At step S1202, the main control unit 306 sets the read transmitting antenna setting angle in the antenna control unit 313. The antenna control unit 313 sets the radiation angle of the transmitting antenna 310, in accordance with the transmitting antenna setting angle. The radiation angle (directivity angle) associated with the transmitting antenna 310 may also be set for the receiving antenna 309. Subsequently, steps S807 to 5810 are executed, and the processing proceeds to step S1203.

At step S1203, the main control unit 306 determines whether transmission of a startup command has been completed for all angles that can be set for the transmitting antenna 310. If not completed, the processing returns to step S1202 to set the next angle and transmit a startup command. Note that if the control station was able to receive a response from a selected dependent station, the processing skips from step S810 to step S811.

According to the present embodiment, the dependent stations wait for a startup command with a wide directivity pattern, and the control station transmits a startup command with a narrow directivity pattern. Further, the control station transmits a startup command and waits for responses, while sequentially changing the directivity direction (radiation direction) of the main beam. By thus scanning the antenna, the dependent stations are readily restarted, even if the positional relation between the control station and the dependent stations changes slightly from when entering sleep mode to when returning from sleep mode.

### Other Embodiments

When the control station is selecting a dependent station to be a relay station, the main control unit 306 may decide a priority order for the dependent stations in accordance with the communication states before entering sleep mode. For example, the main control unit 306 may decide the priority order of the dependent stations in accordance with the favorability of the communication states. In this case, the main control unit 306 selects superordinate dependent stations on a communication path to another dependent wireless station in order, in accordance with the priority order, until a response is received from the other dependent station. Therefore, the main control unit 306 can be seen as an exemplary priority order deciding unit or selection unit. In particular, deciding the priority order of the dependent stations in order of the favorability of the communication states should enable the dependent stations to return from sleep mode with relatively fewer procedures.

In the foregoing embodiments, a dependent station relays a startup command in accordance with a command from the control station requesting relaying. However, a dependent station may autonomously send a startup command, even without receiving a relay command. This is advantageous in that the control station is no longer required to transmit a relay command. Note that the main control unit 306 and the relay processing unit 301 of a dependent station constitute an exemplary autonomous relay unit which relays a startup command to another dependent station subordinate thereto, irrespective of a request from the control station. In this case, the dependent station that transmitted the startup command will relay responses transmitted from other dependent stations to the control station or to a superordinate dependent station.

Embodiment 3 was described in terms of the control station scanning a main beam in the directivity of an antenna. However, a dependent station operating as a relay station may also similarly scan the main beam in the directivity of an antenna, after relaying a startup command to another dependent station subordinate thereto. In this case, the antenna control unit 313 of the dependent station will attempt to receive a response transmitted from another dependent station, by scanning the main beam in the directivity of the receiving antenna.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-248182, filed Sep. 25, 2007, which is hereby incorporated by reference herein in its entirety.

1. A network system having a control wireless apparatus and a plurality of dependent wireless apparatuses, wherein
the control wireless apparatus comprises:
a transmission means for transmitting a sleep command for causing the plurality of dependent wireless apparatuses to enter a sleep mode in which an intermittent receiving operation is performed, and
the dependent wireless apparatuses comprise:
a sleep means for entering a sleep mode in which reception is intermittently performed, on receipt of the sleep command from the control wireless apparatus or via another dependent wireless apparatus; and
a relay means for relaying the received sleep command to another dependent wireless apparatus.

2. A dependent wireless apparatus that changes a communication mode in accordance with an instruction from a control wireless apparatus, comprising:
a receiving means for receiving, from the control wireless apparatus or another dependent wireless apparatus, a sleep command for entering a sleep mode in which an intermittent receiving operation is performed;
a sleep means for entering a sleep mode in which the receiving operation performs intermittently, on receipt of the sleep command by said receiving means; and
a relay means for relaying the received sleep command to another dependent wireless apparatus.

3. A network system having a control wireless apparatus and a plurality of dependent wireless apparatuses, wherein
the control wireless apparatus comprises:
a transmission means for transmitting a startup command for causing a dependent wireless apparatus that has entered a sleep mode in which an intermittent receiving operation is performed to cancel the sleep mode, and
the dependent wireless apparatuses comprise:
a startup means for canceling the sleep mode and enters a startup state, on receipt of the startup command from the control wireless apparatus or via another dependent wireless apparatus; and
a relay means for relaying the received startup command to another dependent wireless apparatus.

4. The network system according to claim 3, wherein the control wireless apparatus further comprises a designation means for designating a dependent wireless apparatus for relaying the startup command.

5. The network system according to claim 3, wherein the dependent wireless apparatuses transmit a startup command in order, on receipt of a relay command for relaying the startup command after the dependent wireless apparatuses are started up by said startup means.

6. The network system according to claim 3, wherein the dependent wireless apparatuses further comprise:
a response transmission means for, on being entered into a startup state by said startup means, transmitting a response notifying that startup has been performed; and
a response relay means for relaying a response from another dependent wireless apparatus to the control wireless apparatus, and
the control wireless apparatus further comprises:
a determination means for determining dependent wireless apparatuses that have entered the startup state, based on received responses.

7. The network system according to claim 6, wherein the control wireless apparatus further comprises an instruction means for h instructing a dependent wireless apparatus to relay the startup command, based on a result of the determination by said determination means.

8. The network system according to claim 7, wherein the control wireless apparatus further comprises:
a storage means for storing information indicating a state of a communication path to each dependent wireless apparatus; and
a selection means for selecting a dependent wireless apparatus for instructing to relay the startup command, based on the state of the communication paths stored by said storage means.

9. The network system according to claim 3, wherein said relay means relays the startup command, if there is a dependent wireless apparatus that is subordinate to the dependent wireless apparatus.

10. The network system according to claim 3, wherein the dependent wireless apparatuses further comprise a control means setting widely a directivity of a receiving antenna during the sleep mode to more than during the startup state.

11. The network system according to claim 3, wherein the control wireless apparatus further comprises a setting means for setting a directivity of a transmitting antenna to a narrow directivity, when transmitting the startup command.

12. The network system according to claim 3, wherein the control wireless apparatus further comprises a switching means sequentially switching a directivity angle of a receiving antenna in order to receive a response to the startup command.

13. A control wireless apparatus that controls a plurality of dependent wireless apparatuses, comprising:
a transmission means for transmitting a startup command for causing a dependent wireless apparatus that has entered a sleep mode in which an intermittent receiving operation is performed to cancel the sleep mode;
a determination means for determining dependent wireless apparatuses that have entered a startup state; and
an instruction means for instructing a dependent wireless apparatus to relay the startup command, based on the determination by said determination means.

14. A dependent wireless apparatus that changes a communication mode in accordance with an instruction from a control wireless apparatus, comprising:
a startup means for, on receipt, from the control wireless apparatus or via another dependent wireless apparatus, of a startup command for cancelling a sleep mode in which an intermittent receiving operation is performed, canceling the sleep mode and enters a startup state; and
a relay means for relaying the received startup command to another dependent wireless apparatus.

15. A control method of a network system having a control wireless apparatus and a plurality of dependent wireless apparatuses, wherein
the control wireless apparatus executes:
a transmission step of transmitting a sleep command for causing the plurality of dependent wireless apparatuses to enter a sleep mode in which an intermittent receiving operation is performed, and
the dependent wireless apparatuses execute:
a sleep step of entering a sleep mode in which reception is intermittently performed, on receipt of the sleep command from the control wireless apparatus or via another dependent wireless apparatus; and
a relay step of relaying the received sleep command to another dependent wireless apparatus.

16. A control method of a network system having a control wireless apparatus and a plurality of dependent wireless apparatuses, wherein
the control wireless apparatus executes:
a transmission step of transmitting a startup command for causing a dependent wireless apparatus that has entered a sleep mode in which an intermittent receiving operation is performed to cancel the sleep mode, and
the dependent wireless apparatuses execute:
a startup step of cancelling the sleep mode and entering a startup state, on receipt of the startup command from the control wireless apparatus or via another dependent wireless apparatus; and
a relay step of relaying the received startup command to another dependent wireless apparatus.
